(19) United States
(12) Patent Application Publication
(10) Pub. No.: US 2003/0020253 A1
(43) Pub. Date: Jan. 30, 2003

(54) Guard railing arrangement for tankers

(75) Inventors: Andre Gerard Albert Bosman, Kent Town (AU); Devron Jene Booth, Lonsdale (AU); Gerard Albert Bosman, Flagstaff Hill (AU)

Correspondence Address: FINNEGAN, HENDERSON, FARABOW, GARRETT &, DUNNER LLP, 1300 I STREET, NW, WASHINGTON, DC, 20006, US

(73) Assignee: BOOTH ENGINEERING PTY LTD, Adelaide (AU)

(21) Appl. No.: 10/121,543

(22) Filed: Apr. 15, 2002

Related U.S. Application Data
(63) Continuation of application No. 09/223,771, filed on Dec. 31, 1998, now abandoned.

(51) Int. Cl. B60R 3/00

(52) U.S. Cl. 280/164.1

(57) ABSTRACT

A guard railing arrangement on a tanker which extends, when in an erect position, along both sides of a walk way extending along a top of a tank of the tanker. The guard railing is supported so as to be foldable when not in use and there are described arrangements adjacent access ladders to enable the railing to be raised prior to use. Further described are arrangements of struts to assist in support of the railing structure and modifications to make the guard railing appropriate for a hard back tank as well as other forms of tank.

This invention relates to a guard railing arrangement for tankers and has particular application to a railing arrangement that can be folded when not being used.

### BRIEF DESCRIPTION OF THE PRIOR ART

The invention applies to motor vehicles that transport liquid or other materials such as powders in tanks where access to the tank is achieved through uppermost openings which may be closed by lids.

It is conventional that an operator will climb onto the top of the tank and then walk along a walkway along the top of the tank to both open and close such lids and to otherwise direct pipes into or out from respective openings.

The shape of most of these tanks is such that they are either circular or oval in cross section and have this constant shape along most of the length of the tank. This means usually that there is a relatively narrow walkway extending along the apex of the tank and there is nothing to protect an operator if for any reason they slip to a side of the tank in that the tank shape will slope away and downwardly on both sides of any walkway.

An example of prior art however is Australian patent application AU-A-14196/88 in which there is described a guard rail assembly for a vehicle walkway comprising a rail and actuating means to move the guard rail assembly from a stored position to a raised operative position and there is disclosed that the actuating means are rams pneumatically operable and the guard rail is positioned to extend along one side only of the vehicle walkway so that when folded, it is folded or laid over from the one side of the walkway across the walkway to an opposite side.

It is an object of this invention that there should be provided an arrangement that can be safer or at the least provide the public with a useful alternative.

### SUMMARY OF THE INVENTION

In accord with this invention then there is proposed a guard railing arrangement on a tanker which extends, when in an erect position, along both sides of a walkway extending along a top of the tank.

A first problem with such a proposal is that any railing in a useful position will necessarily project somewhat higher than the tank and this will reduce clearance that the motor vehicle might otherwise have and in the event of contact with branches of trees or other overhead structures, can be damaged or even destroyed.

According in preference there is proposed a guard railing arrangement on a tanker where the guard railing is adapted to assume two positions one of which is an erect position providing protection on both sides of the walkway and a second of which is a folded position.

In preference, there is proposed on a tank of a tanker a guard railing to provide a safety barrier along each side of an uppermost walkway of the tank which extends in a forward to rearward direction along the tank, where the railing can be held in at least two positions one of which is a lowered storage position and the other of which is a raised barrier position, a ladder extending from the side of the tank to an access part of the walkway on the tank, and control means connected to the guard railing so as to enable a change of the position of the guard railing.

In preference, in the folded position, the guard railing arrangement is lowered somewhat from an erect position to an extent so that it will not add substantially to any regulation clearance height required of the motor vehicle, and furthermore will not stand so proud as to add significantly to wind resistance when the tanker is being driven.

One of the next problems however is that the arrangement needs to be able to be manufactured and installed relatively economically while at the same time being able to provide good safety as far as an operator is concerned.

In preference then, the railing arrangement includes an uppermost rail which substantially continuously extends to follow a path above a part of the perimeter of the walkway where the said part of the perimeter includes a first side of the walkway, at least one end of the walkway and an opposite side to the said first side of the walkway.

In preference there are a plurality of struts an upper end of which is each pivotally secured to the railing and a lower end of which is secured in a pivotal manner relative to the tank and in the adjacent vicinity of the respective portion of the walkway.

In preference, the struts are arranged in pairs and are formed so as to be of U shape so that the respective legs of the U shape provide the struts and the cross piece provides additional strength for the respective struts and ensures that the struts when being changed in position when the railing is to be changed from an erect to a folded position or otherwise, then such an arrangement does assist this.

A serious further difficulty is experienced in that even though such a guard railing arrangement is provided, an operator will not take advantage of this and accordingly will not bother to erect the guard railing when access to the various lids or the walkway is required.

In preference then there is provided a manually operable control means which is positioned in the adjacent vicinity of an access ladder that would be used for an operator to gain access to the walkway.

Further however in preference, there is provided a cradle of generally U shape having each end pivotally secured one to each side of an access ladder, an interconnecting rod being secured to each respective leg and extending at its other end to a respective one of the struts, the connections being such as to allow for pivotal relative movement between the connections, and further being such that with the cradle in a first position, this will maintain the guard railing in a folded position, and in a further position of the cradle, the guard railing is positioned in an erect position.

In preference, by arranging that the cradle is positioned across the ladder to gain access to the tank, it is firstly extremely convenient for a person intending to use the ladder, to then simply grab the cradle and push it from one position to another to erect the guard railing, and of course, when returning, it is not going to be so easily forgotten because it is also projecting across the ladder as the person descends.

One of the difficulties is to propose a system so that once the cradle has been operated, the guard railing can be easily maintained in an erect position and in accord with the further feature of this invention, in preference there is provided that each leg of the cradle has a pivot position relative to the tank such that the pivot connection to the connecting rod can be pushed through an over centre position when the guard railing is erect and thereby locking this in position without any additional devices or mechanisms.

In a further feature in preference, there is provided that there are means to interlock with the cradle when this is in the position with the guard railing in a folded position.

This had advantages which were set out in the previous specification but had one disadvantage which was in the event that the ladder was secured to the rear end of the tank, then if a further tank as a trailer was attached to the first tank, there may well simply not be room for such a cradle to be used.

There is proposed accordingly, that the controller can be arranged to provide sufficient range of movement and as well, mechanical advantage to control the position of the guard railing but in such a way that there will not be substantial protrusion more rearwardly during such operation.

One of the problems of having two sides to a guard railing is that in order for this to be strong, there either needs to be substantial controlling frames or an arrangement that allows for a minimal additional framed system.

Previously described, there was the system in which upright studs were provided by being the legs of a U shaped frame and that there were plurality of these distributed along the length of the walkway.

This provides firstly substantial advantage from the point of view that each stud is supported at its base by a cross piece which is either integral with the upright or permanently and strongly connected thereto and secondly, the relative orientation the uprights is controlled, one with respect to the other, again by reason of the cross piece being strongly coupled to each.

What this means is that once the studs or the guard railing formed by these is raised into an erected position, then there is substantial fail safe protection against pressures from someone on the walkway falling sideways against the barrier.

This compares for instance with the situation with the prior art where the position of the guard railing is controlled by a pneumatic ram so that if a person was falling over the side of a tank opposite to which the guard railing is located, and grabbed the guard railing, then the strength of the guard railing will depend upon the degree to which the pneumatic ram is inflated and this is obviously vulnerable.

In preference the safety rail has an upper rail which extends along both sides of a walkway and at an end the furthest from an access ladder, the rail extends across from one side of the walkway to the other at an uppermost location relative to the walkway.

Hitherto, there have been provided studs which are positioned at spaced apart locations along the length of the safety railing arrangement and such that in respect of each stud, each stud is supported strongly by being one leg of a U shaped member where the other leg is the stud on an opposite side of the walkway.

In this way then, by pivotably supporting the U shaped member on each of two sides of the walkway, the cross-piece joining the two legs of the U shape then provides substantial strength to assist in stability of the studs when the safety railing arrangement is in an erect position.

The problem with this arrangement however is that in some installations especially for instance in a tanker arrangement with what is called a ‘strong back’, there is a coving to which a pivot support for each stud will be appropriately secured but this would be implicitly substantially above the actual walkway uppermost supporting surface on to which people would walk.

If then, the proposal of using two studs joined across their bottom ends by a cross piece so as to form a U shape is used, then there are potentially problems.

A first and perhaps the major problem is that the cross piece will implicitly be forced to move through a substantial radius when the stud is changed from a erect position to a storage position and this will implicitly need substantial clearance along the top of the walkway.

The problem is that tanks of this type have uppermost openings and lids at positions along the length of the walkway which are not standard or exactly repeated tanker for tanker.

This means that if the lids are too close together, there may simply may not be room for the cross pieces to be positioned in this way, or otherwise, each safety rail arrangement has to be uniquely designed and then tested for strength in connection with every individual tanker. This would make it somewhat more difficult for continuing installations and significantly more expensive.

In preference then there is further proposed a safety rail arrangement on a vehicle tanker including a retractable safety rail extending along the top of the tanker, and an access ladder positioned along the end of the tank to provide access to the passageway defined by the safety rail, means to effect a change from a retracted to an erect position of the safety rail, the arrangement being characterised in that the safety rail is comprised with a rail arrangement with a rail positioned on each side of a walkway extending along the top of the tanker, the rail arrangement having a plurality of studs, each stud having a lower end pivotably supported with respect to the tank whereby to be rotatable about an axis aligned to extend transversely to a forward to rearward direction of the tanker, and a support abutment positioned to be adjoining the stud when erect and above the pivot axis.

In preference, the support abutment comprises an abutment that is positioned on an outer side of the rail when in an erect position. Further it is positioned above any pivot connections so that when erect, the stud is further supported by such an abutment against pressure to twist the stud outwardly.

In preference, the abutment includes an abutting support on both an outer side, and an inner side, in both cases substantially above the pivot connection of the respective stud.

In preference, the abutment also includes a rest for an adjacent stud when in a lowered position.

In preference, the abutment is a U-shape in cross section and is such that the stud will in an erect position nest within the U shape which thereby provides support in directions other than in the lowering direction of the stud.

By having such abutting support, each stud can be made much more stable, and in practice it has been found that it can result in the possible removal entirely of any cross piece between studs on the safety rail on respective sides of the walkway.

In preference, a rail arrangement with a rail positioned on each side of the walkway extends along the top of a tanker, the rail arrangement extending from an entry location on one side of the tanker, toward a first end of the tanker, across from one side of the walkway to the other, extending from a first end of the tanker to the other end of the tanker, extending back across the walkway and then returning to the other side of the access location.

Accordingly, in preference there are a plurality of studs pivotally secured at a lower end to a portion of the top of the tanker and having their upper end pivotally secured to a rail which extends around the pathway described. There are a plurality of studs located at spaced apart intervals to provide for sufficient support when the guard railing system is in an erected or raised position. One of the difficulties with this arrangement however, is to enable in an economic and effective way, an operator to raise or lower the guard railing prior to or subsequent to access along the walkway by the user.

In preference, there is provided a control arm located adjacent a ladder secured to a side of the tanker and such that in one position, there are means coupling the lever arm to the guard railing such that it will be held in a raised position, and in a further position of the lever arm, the guard railing is in a lowered position.

Whereas within access, mechanical links effecting this coupling can be by rigid arms, the problem now however is to achieve an effective control joining of a control level arm to the guard railing without undue complexity or cost, interfering with access up the ladder and into an area bounded by the safety rail, and such that the safety rail when erected can be held reasonably securely in such an upright position to provide stabilising support.

In preference this is achieved by providing for a cable to be extended from the controlling lever arm which is directed from the lever arm around the guide to be secured to a portion of one of the studs.

In preference, the lever arm is comprised of a cradle so that there are two arms each having at an inner end a pivot support relative to the ladder.

There are two cables one with respect to each of the arms of the U shaped cradle and each extending respectively around a guide member at the top of the tank to be secured each to a respective side of the walkway to a respective stud in that location.

The arrangement is such that when the cradle is pulled down so as to rotate about its supporting pivot, this in turn will cause the respective cables to be tightened and force the stud to which the respective cables are attached to start to lift and in turn both because there are an upper most safety rail and a mid position cable, this lifting effect on one stud will cause the remainder of the studs to lift as well.

In this relatively simple way then, lifting and lowering of the barrier can be readily achieved and because the barrier extends around both sides of the walkway, and further, studs defining the barrier are each pivoted so that as to be rotatable about a transverse axis where the transverse orientation is transversed to a forward to rearward direction of the tanker.

The lifting and lowering forces are generally transmitted from the barrier on one side of the walkway to the barrier on the other both by reason of respective cables coupling one or more of the studs, but also the fact that there is this crossing between the barriers on both sides which provides significantly increased stability.

These and other important features will now be further understood when described with reference to a preferred embodiment which shall now be described with the assistance of drawings wherein:

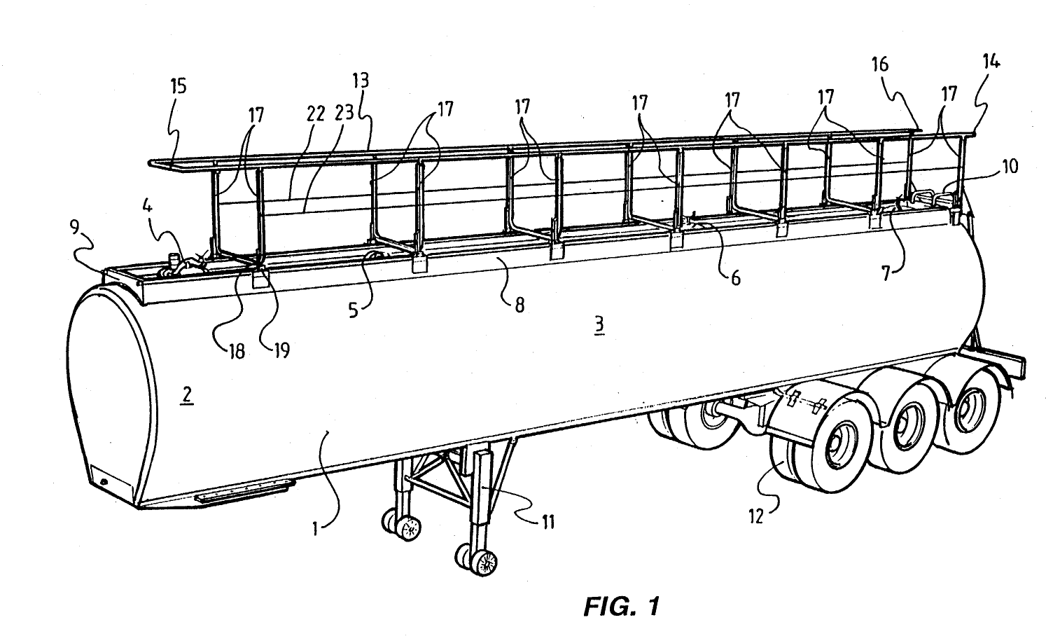

FIG. 1 is a perspective view of the tank of a motor vehicle the tank being shown separated from the prime mover and having a guard railing arrangement in an erected status on a top of the tank in accordance with the first embodiment,

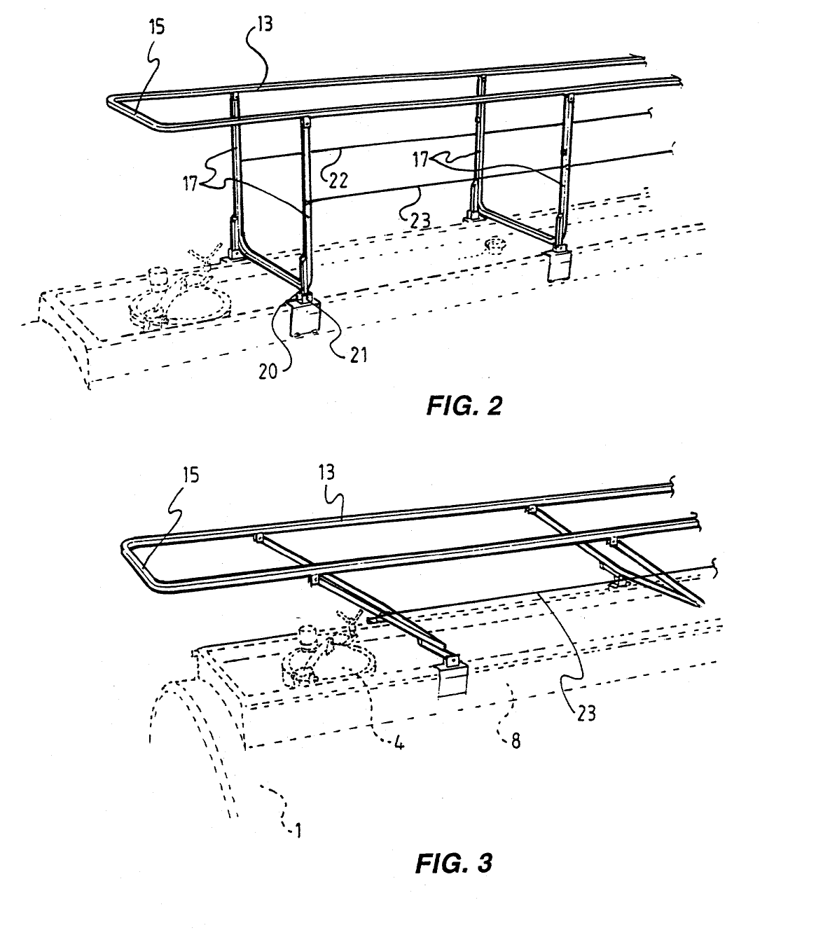

FIG. 2 is a perspective view of an enlarged part of the end of the guard railing arrangement as in the first embodiment showing more of the detail of the walkway and top of the tanker in dotted outline,

FIG. 3 is the same view as in FIG. 2 except that the guard railing is now being in a partially folded position,

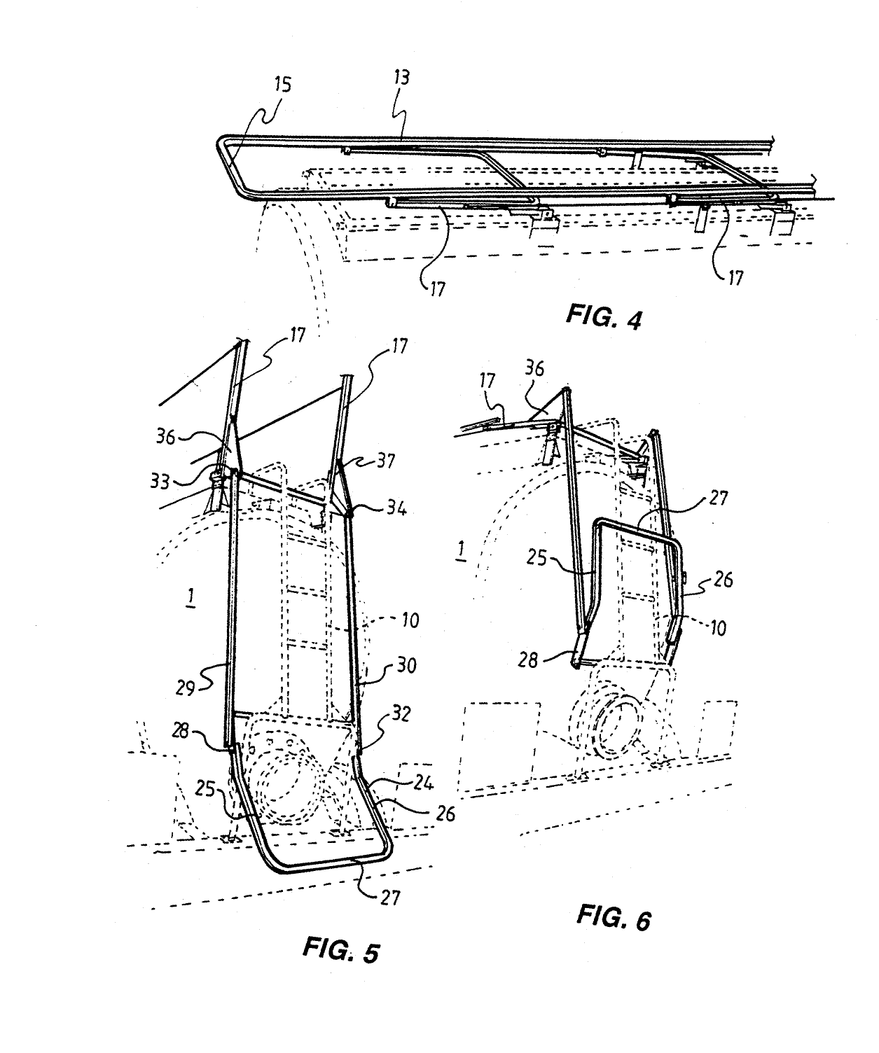

FIG. 4 is the same view as in FIGS. 2 & 3 showing the guard rail in a fully folded position,

FIG. 5 is a perspective view of the end of the tank showing in dotted outline an access ladder to a walkway on the top of the tank and a manually operable control arrangement for controlling the status of the guard railing according to the first embodiment,

FIG. 6 is the same view as in FIG. 5 except that the manually operable means are in a position in which the guard railing is in a fully lowered position,

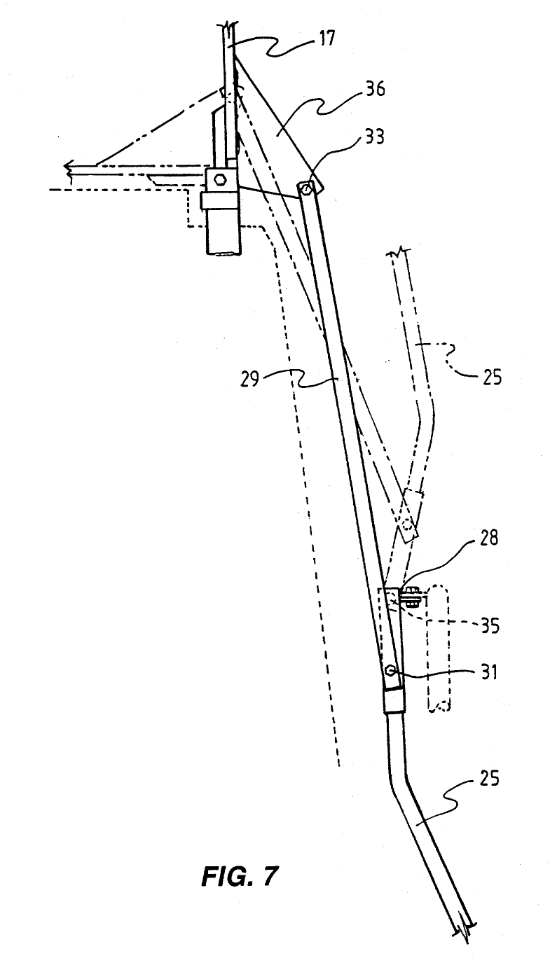

FIG. 7 is a side view of the arrangement as shown specifically in FIG. 5 except that the control arm in this case is positioned relative to the respective pivot points so that the control cradle is in a locked position by reason of the control rod being in an over centre position,

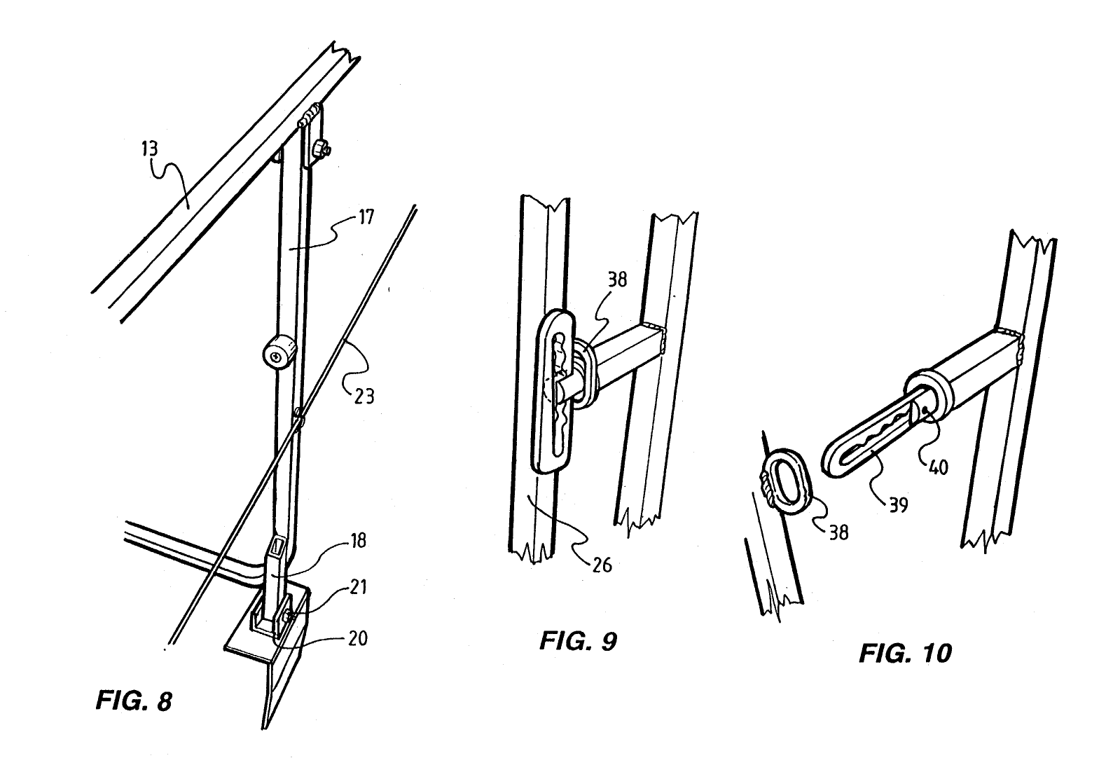

FIG. 8 is an enlarged perspective view of a portion of the guard railing arrangement according to the first embodiment,

FIG. 9 is an arrangement effecting an interlocking of the cradle with respect to the ladder when the cradle is in a position as is shown in FIG. 6, and

FIG. 10 is the same view as in FIG. 9 except that the interlocking device is in a release condition.

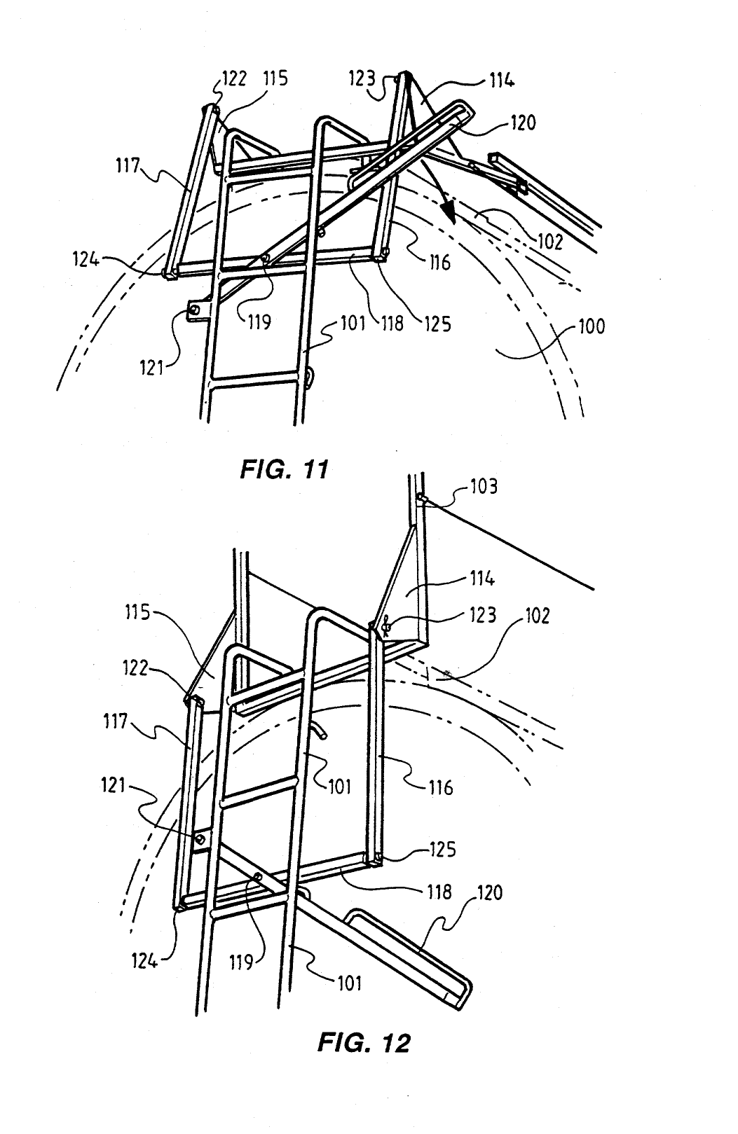

FIG. 11 is a perspective view of an operating part of the arrangement in accord with a second embodiment with the guard railing in a folded or lowered position and a control arm in a position effecting this,

FIG. 12 is approximately the same view as in FIG. 11 viewed again from the rear of a tank of a vehicle with the walkway in a erected position and the control arm accordingly positioned,

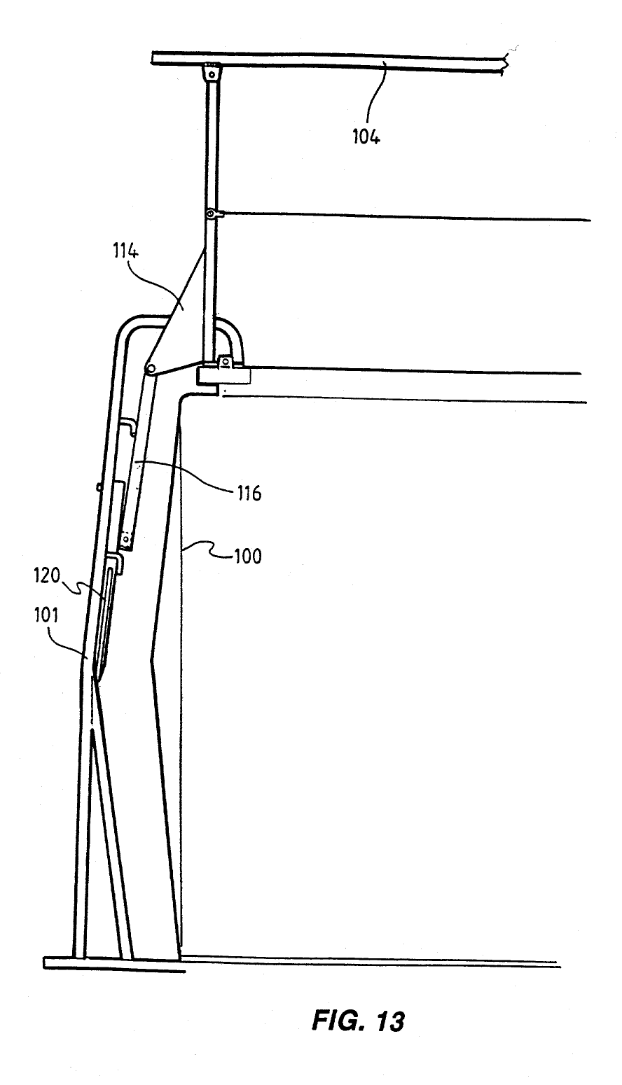

FIG. 13 is a side view of the arrangement when in the position as in FIG. 12 with the guard railing in an erected position,

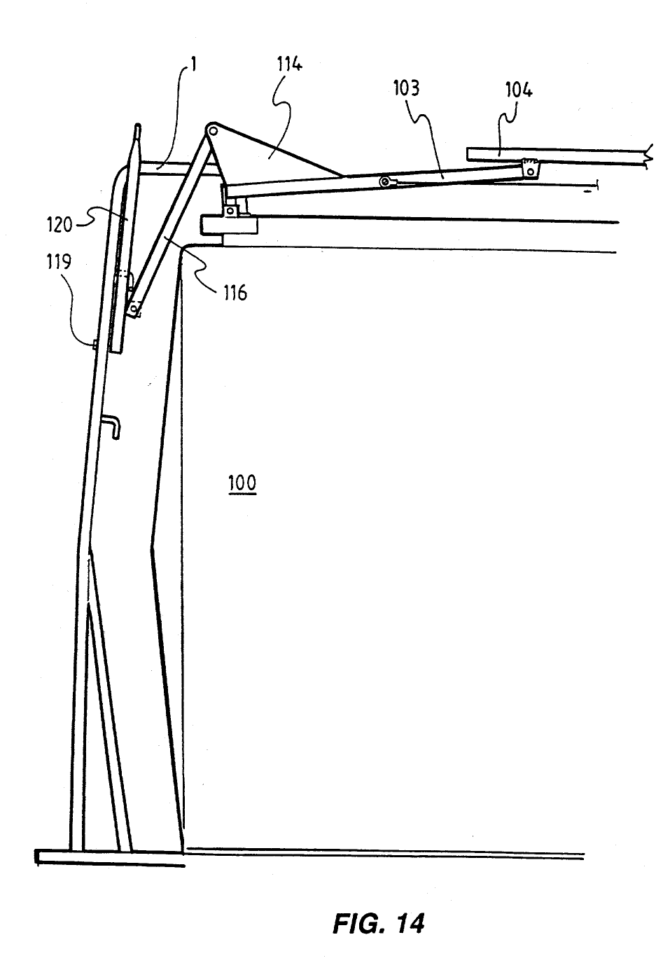

FIG. 14 is the same side view as in FIG. 13 with however the guard railing in a lowered or folded position,

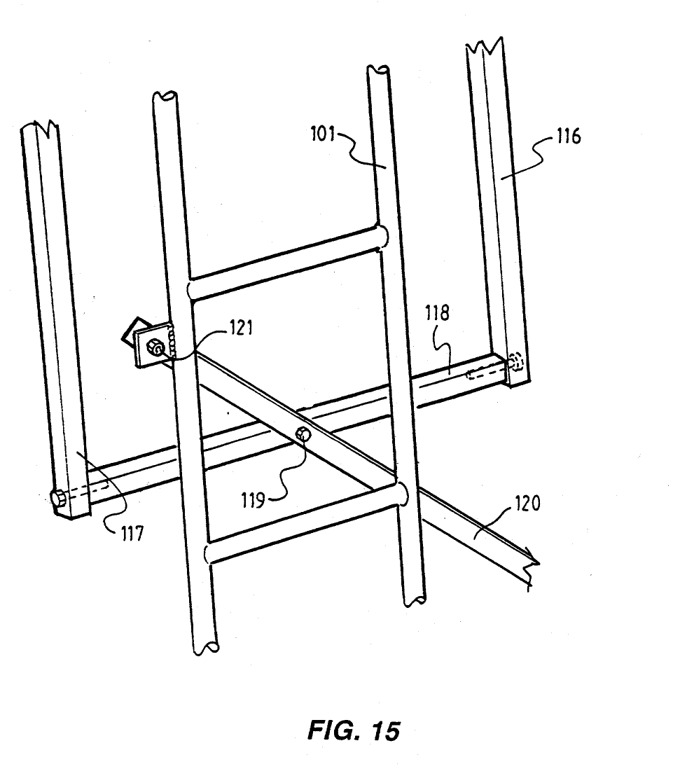

FIG. 15 is an alternative perspective view of the elements including the control arm as shown in FIG. 12,

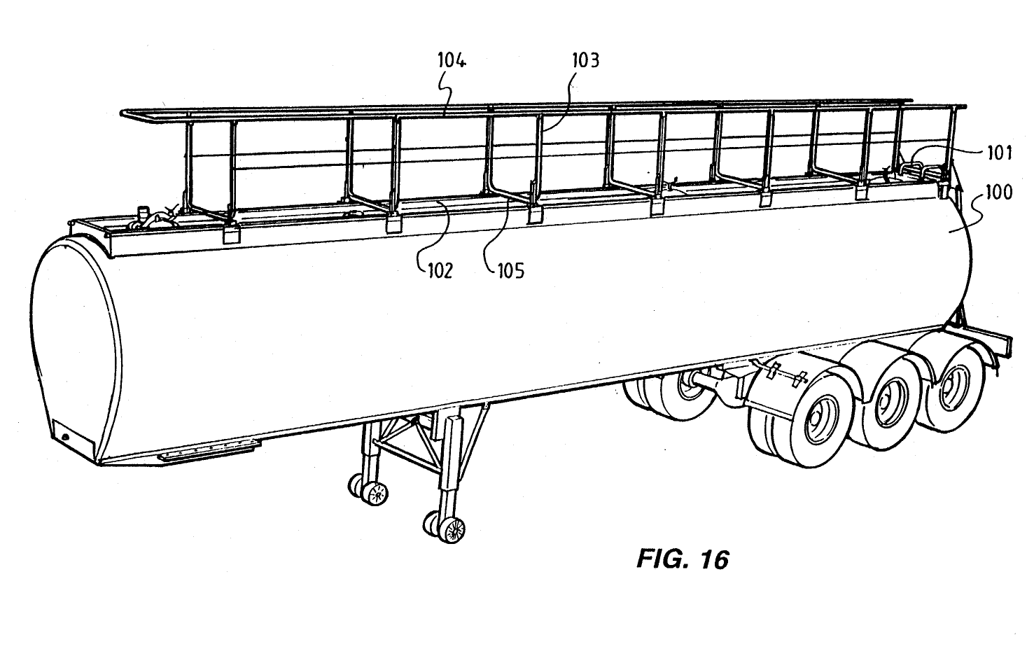

FIG. 16 is a perspective view of a semi trailer tank with an erected guard railing in accordance with this invention and in accordance with the embodiment,

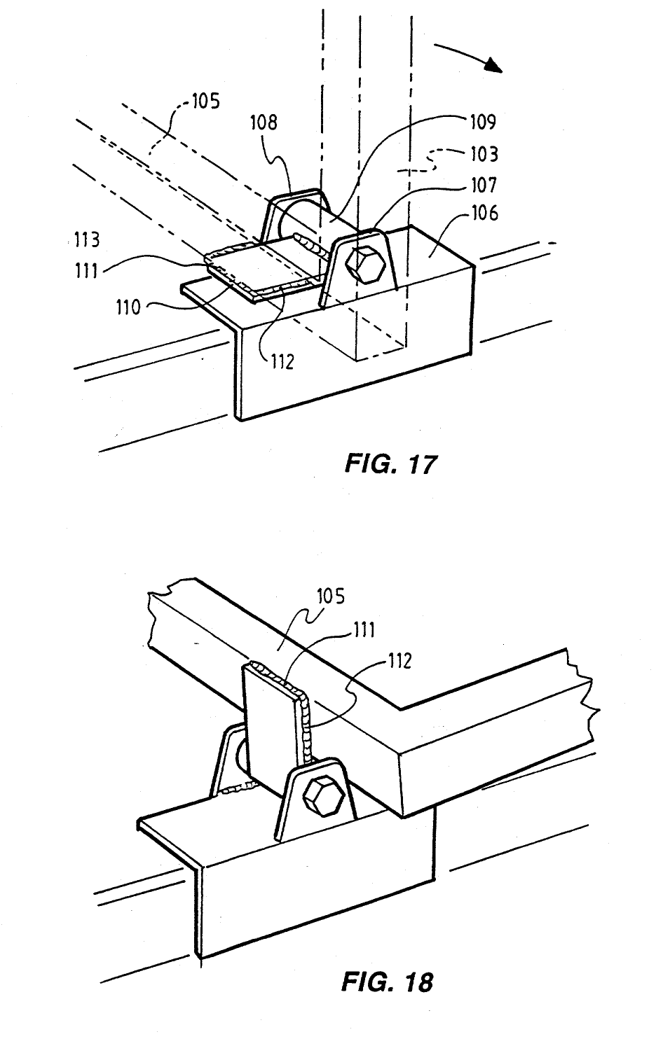

FIG. 17 is a perspective view with dotted outline of a hinging system which has advantage in connection with support of the respective studs and,

FIG. 18 is the same view as in view 17 with the studs in a folded position.

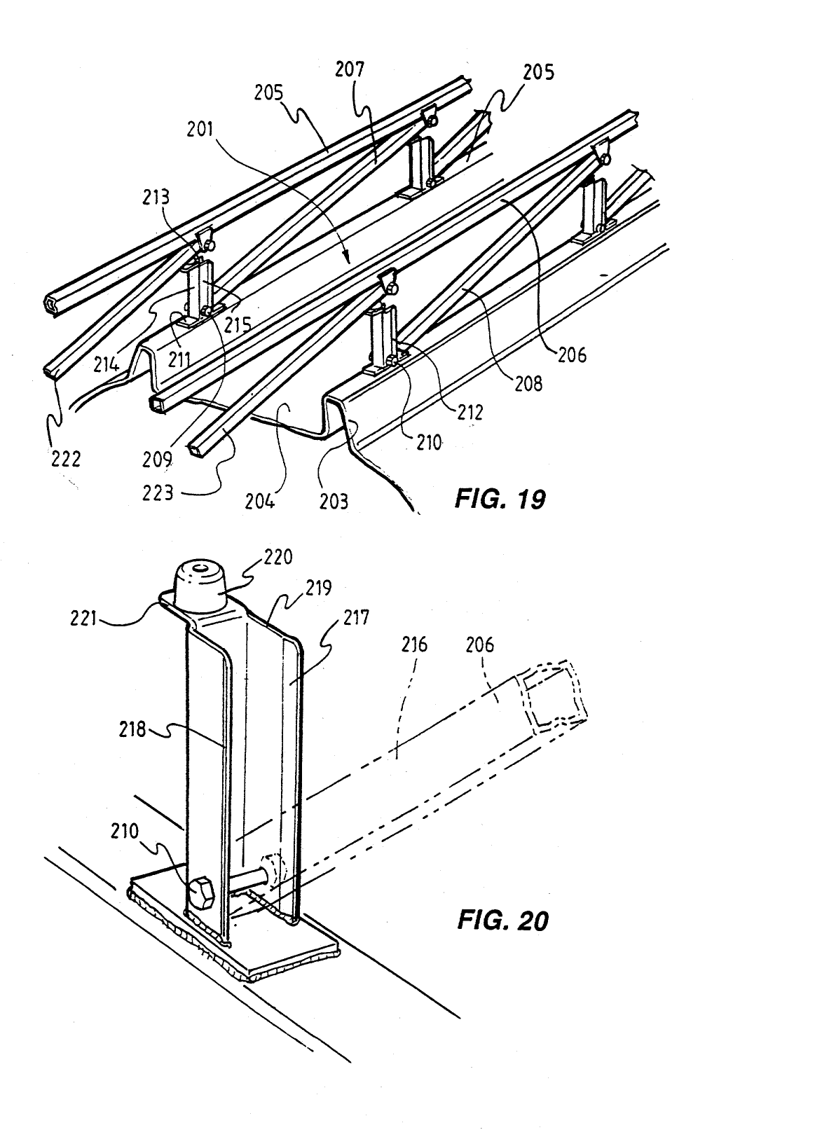

FIG. 19 is a partial cutaway view of the top of a tanker having a strong back type construction and there is shown two studs, one positioned on each side of a walkway in accordance with a third embodiment of this invention these being in each case shown in a storage position,

FIG. 20 is a perspective view of a portion the support shown in FIG. 19.

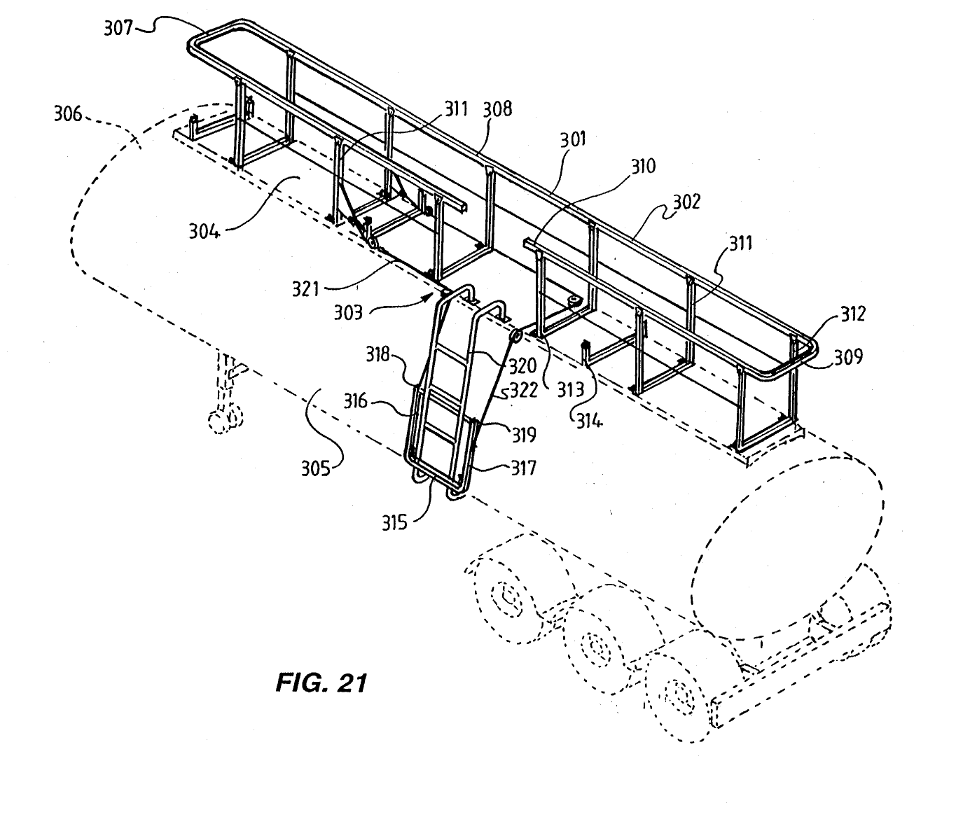

FIG. 21 is a perspective view of the fourth embodiment when applied to a tanker as shown in dotted outline. The safety being shown in the erect position.

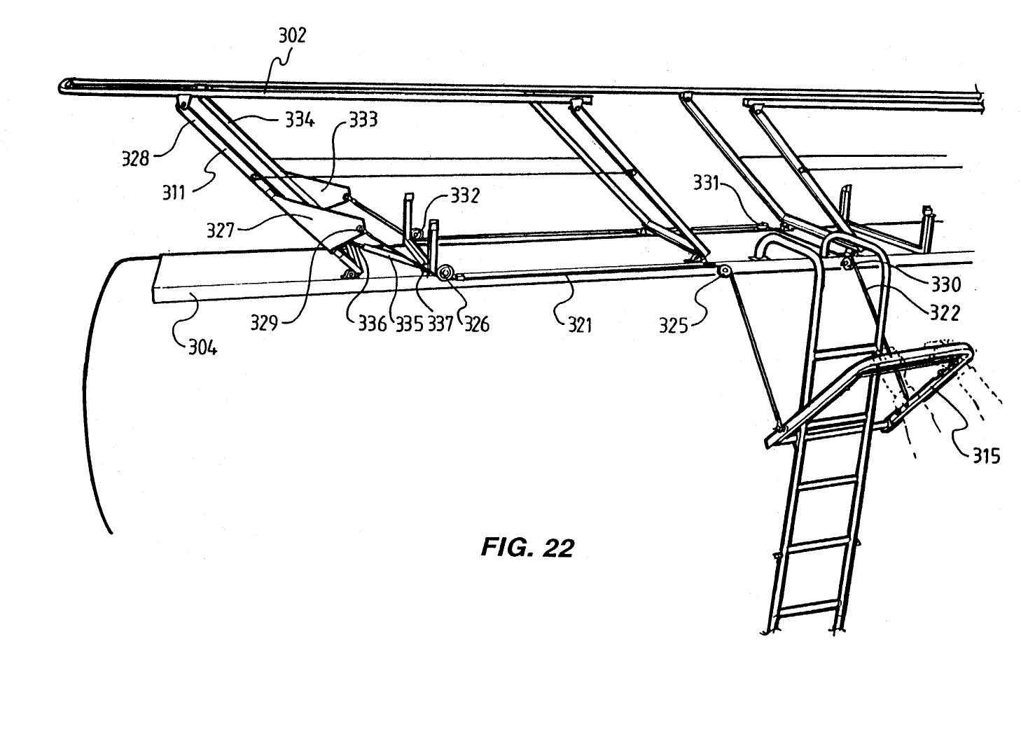

FIG. 22 Is a further perspective view of the fourth embodiment from a side showing the guard railing in a partially erect position,

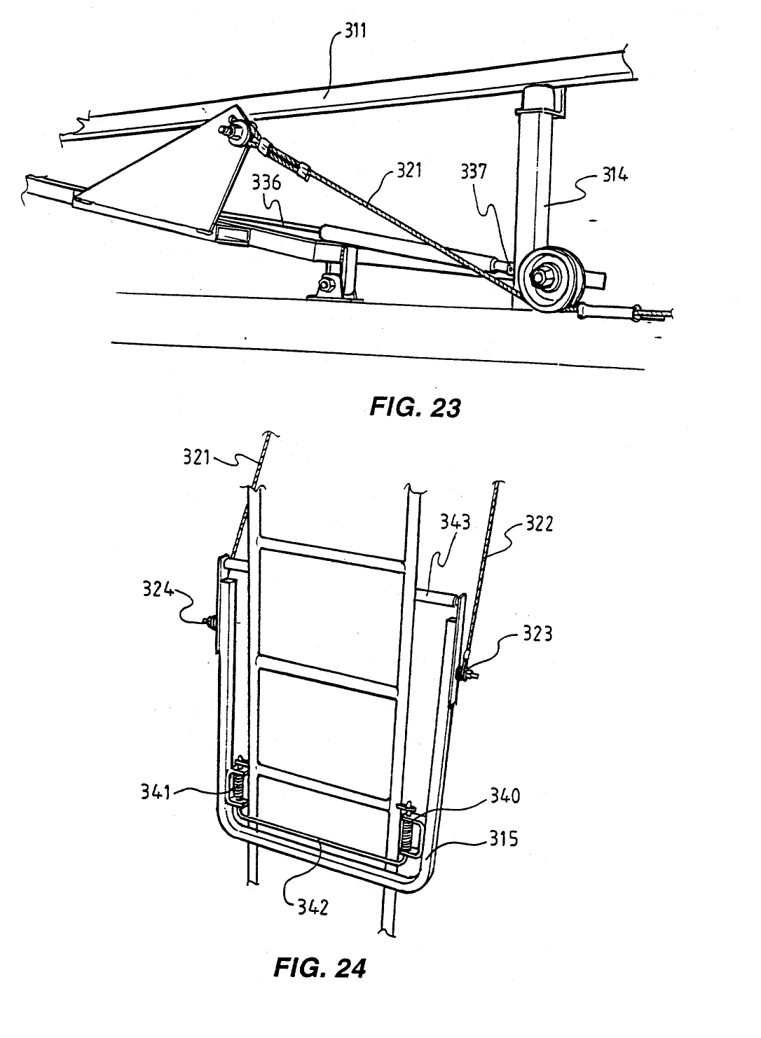

FIG. 23 Is an enlarged view of a portion of the guard railing of the fourth embodiment shown in the fitting of the cable to one of the studs; and

FIG. 24 is a perspective view of the cradle according to the fourth embodiment showing the control system including a safety interlock.

Now referring in detail to the drawings and the first embodiment the tanker 1 is of a conventional style having a tank 2 which is of a shape having a generally circularly shaped cross section along its length so that the sides such as 3, if an operator should try to gain purchase on this would slip off the sides because it is inclined outwardly and downwardly when located as shown in the FIG. 1 on a horizontal surface.

The tank 2 has a plurality of openings which are capped by appropriate lids at 4, 5, 6 and 7 and a walkway is defined by a skirt 8 which extends down both sides of the walkway and across the end at 9.

Access to the walkway is achieved by access to ladder 10 which in this case is located at the rear of the tank 1.

This then is the existing system with conventional peripheral items such as temporary supporting legs 11 and conventional road transport wheels such as at 12.

The railing 13 extends continuously from the back and one side of the truck 1 at 14, above the skirt 8 to a forward position at 15 where it crosses over and extends rearwardly to a rearward most position on the other side at 16.

This railing 13 is supported by a plurality of struts which are shown at 17 which in each case are comprised of being the legs of a U shape member the upper end of which in each case is pivotally secured about a transverse axis to the railing 13 and at a lower end also in respect of a transverse axis through attached arm 18 to a pivot connection 19 attached to the skirt 8 of the tanker 1.

This is repeated for each strut 17 and is probably best shown in the perspective view in FIG. 8 where there is shown the detail which includes a U shape bracket 20 which is attached to the skirt 8 and a nut and bolt passing neutrally through the legs of the U shape bracket 20 and the member 18 at 21.

Accordingly, the railing 13 and a middle cable 22 on the one side and 23 on the other provide effective protection for an operator walking down the walkway provided the railing is in the erected position as is shown in FIG. 1 and 2.

There are manually operable means shown specifically in FIGS. 5, 6 & 7 which enable an operator to quickly and easily change the status of the guard railing from an erected position to a fully folded position or vice versa.

To achieve this there is firstly provided a cradle which is made in the shape of a U shape so as to have two legs at 25 in the one case and 26 in the other and a base at 27 which acts as a handle.

The cradle at the outer end of each leg is pivotally secured to a bracket 28 which is fixed and is a part of the tanker 1 and there are two connecting rods 29 in the one case and 30 in the other which extend between a pivotal connection at 31 in respect of the leg 25 and 32 in respect of leg 26 such that as is particularly shown in FIG. 7, the alignment of rod 29 and 30 in each case or perhaps more particularly, a line connecting pivot connection 31 and pivot connection 33 in the one case and 32 and 34 in the other are past the axis of pivot connection at 35.

This therefore provides an over centre locking effect.

The pivot connection 33 incidentally is connected by way of bracket 36 to the strut 17.

One of the advantages of the arrangement described is that there are the two rods 29 and 30 which respectively hold through their pivotal connections at 33 and 34 (36 in the one case and 37 in the other) to the struts 17.

This works then because when a person intending to climb the ladder 10 and go on top of the tanker 1, faces the ladder, the cradle 27 is presented directly in front of the operator and it is therefore both natural and obvious for the operator to grab the handle 27 particularly when this is shown in the position as in FIG. 6 and which therefore in this way is generally in the way of the person climbing the ladder 10 and then simply pull this down with the result that this will also bear down on the respective brackets 36 and 37 which in turn pull up the struts 17 and through these the railing 13.

When the cradle is in the position as shown in FIG. 6, a keeper 39 is adapted to pass through the ring 38 and then turn about a pivot so as to act as shown in FIG. 9 as a permanent keeper.

This illustrates a first embodiment of the invention.

Having a cradle that is directly across an access ladder which is the operating lever to erect or fold down the guard railing is of significant advantage and further, the technique to provide an over centre locking when the cradle is in its lowermost position to hold the guard railing in its elevated position means there is minimal further action necessary by an operator and therefore provides a substantial encouragement for them to use the guard railing in an erect position when on the tank.

A further feature that can be used in connection with the invention and in connection with the embodiment described, is an arrangement in which each of the struts being of U shape have a base extending between the legs which extend across the walkway.

In order to make it safer for people to walk along the walkway, the pivotal axis position is offset to an axis that passes through the base so that when the respective struts are in a raised position, the cross piece forming the base of each U shape strut is caused to be as low as possible in respect of the top of the walkway to reduce potential accidental tripping that might otherwise occur from people using the walkway.

In preference, the base is lowered when the strut is raised so that it is effectively flush with the top of the tanker.

In a practical example, the supporting pivot is offset 10 mm to the line of elongation of the base.

Further, while the shape of the struts and base have been shown in the embodiment as being comprised of square cross section tube, this can be modified especially for the base so that in order to again facilitate reduction of height, the tube can be flattened at least across a mid area to reduce again the total height above the surface of the walkway.

Referring now to the second embodiment, there is a tank 100 which as shown in FIGS. 11, 12, 13 & 14 illustrates the rear of the tank of a type that is used as a trailer for motor vehicles. There is a ladder 101 permanently affixed to extend from the rear of the tank from a lower part of the tank to an uppermost walkway at 102.

A guard railing exists which includes a plurality of spaced apart upright studs 103 which have at their upper ends rigid rails 104 which are pivotably secured to the upper end of the studs 103.

The lower end of each of the studs 103 is directly secured by a cross piece 105 which therefore provides that there are two respective studs one to each side of the walkway or catwalk 102 and this cross piece simply makes sure that both move together because they are pivoted by a pivot connection which is best seen in FIGS. 17 and 18.

Here then, there is shown a bracket 106 to which there is secured two upright wings 107 and 108 which hold between them a bush 109 which itself has a tab 110 secured thereto.

This tab 110 is secured to the cross piece 105 by being welded at placed such as shown at 111, 112 and 113.

This arrangement allows for the cross piece to be positioned fairly close to the uppermost surface of the walkway 102 and therefore not provide an unnecessarily high barrier for those that might use the walkway.

The method of raising and lowering the studs and the other parts providing the safety railing includes therefore a bracket 114 on the one side and 115 on the other each of which extends rearwardly to provide a pivotal connection point for a strut 116 in the one case and 117 in the other which are connected to a cross piece 118 which is secured at a middle point to a control arm 120.

The control arm has one end pivotably secured at 121 to the ladder 101 and by use of this as a pivot support, when pulled down will then pull with it the cross piece 118, and this through the members 116, 117, cause a rotation force and therefore a raising pressure through the brackets 114 and 115 to the studs 103 interconnected thereto.

With the arrangement described, there is allowable pivotal movement at the upper ends of members 117 and 116 at 122 and 123 and again there is pivotal freedom at the bottom of these member at 124 and 125.

As can now be seen, such an arrangement provides for a relatively simple assembly which can therefore be economically manufactured and assembled, which however, will provide for handle 120 to be able to be moved in a way which will therefore not extend rearwardly from the tank at all.

Further, such an arrangement makes it easier to locate a cover plate or cover plates which when the handle is raised, block access to one or more of the steps by a person climbing the ladder, but allow access to the same steps when the handle is lowered.

This can be readily achieved by for instance either having a single plate the size and position of which would be such as to cover the area between two adjacent steps and would be positioned in one case with the handle lifted, so that access to one step would be blocked, and when positioned with the handle being in a lowered position, in other words the safety rails being in an elevated position, all of the steps would be accessible for the persons using the steps to gain access to the walkway.

Now referring to the FIGS. 19 and 20, the tanker 201 of strong back type, includes coving 202 on one side and 203 on the other in the conventional way to thereby define there between a walkway 204.

Within the walkway but not shown specifically are openings with lids which provide access to the tank 201.

As it is necessary from time to time for operators to climb up to the top of the tank and get access to the openings and, the purpose of the safety rail arrangement is to provide support for the operator when on the top of the tank.

Not shown but provided is a ladder at one end of the tank and control means such as a control arm by which the storage position or erect position of the safety rails such as 205 and 206 can be determined.

The safety rail arrangement is comprised of a railing which extends along fully one side of the top of the tank, across a further or distal end from the end providing access through a ladder, and back through the other railing on the other side of the walkway 204.

The railing in this case comprises an uppermost rail as shown at 205 and 206 and this is supported by studs such as at 207 in the one case and 208 in the other which are pivotably secured for instance at 9 in the one case and 210 in the other to a bracket 211 in one case and 212 in the other which is welded to the respective covings 202 and 203.

In accordance with this invention the bracket includes an upstanding supporting abutment arrangement which is provided in the case of bracket 11 by an outerside 213, a backside 214, and an inner side 215.

These together define then a nesting shape which will hold with additional support an end 216 of the stud.

In order to assist in location of the stud, there are inclined wings 217 in the case of the outer side and 218 in the case of the inner side arranged to assist in easy sliding location with respect to the respective cross sections hollow stud typically 206 or 207.

The pivot connection is positioned at a lower most end of the U shaped cross section bracket so that in effect the upper end of the bracket such as typically at 219 will provide substantial location and abutting support for the stud 206.

It will be noticed in this description that there is no cross piece between the respective studs for instance between 206 and 207 so that by this arrangement, the studs when in an erect position can be positionally supported to a sufficient extent by simply the extra height provided by the inner, outer and end abutments.

An additional feature is a resilient support 220 which is supported on the top of lip 221 so that an adjacent stud such as at 222 in the one case and 223 in the other can rest thereon when in a lowered position.

Referring in detail to FIGS. 21, 22, 23 and 24, the guard railing one is comprised of an uppermost tubular rail 302, which extends from an access location at 303, fully around an uppermost walkway 304, of the tanker 305.

This then includes extending to an end 306, where the rail crosses over at 307, to an opposite side and returns down the side 308, to an opposite end at 309 to then return to the opposite side 310 of the access location at 303.

The guard railing is comprised in each case of a plurality of studs typically shown at 311 and 312 each of which are pivoted at a lower end such as at 313 so as to pivot around an axis which is transversed to an elongate direction of the tanker.

Each of the studs is provided with a support arm such as at 314 so that when in a lowered position they will be supported above the walkway 304.

The control system however to raise and lower the barrier includes a cradle 315 which comprises two legs 316 and 317 which are each pivotally supported at 318 and 319 to a frame supported by the ladder 320 and there are two cables 321 and 322 an end of which is each secured to a respective one of the legs 316 in the one case and 317 in the other at a position along the length of the respective lengths.

This is generally most clearly shown in FIG. 4 where the joint is shown at 323 in the one case and 324 in the other.

The cable 321 is positioned by being directed to pass around fully 325 and then around fully 326 each of which pulleys are secured so as to be rotatable relative to the walkway 304.

The further end of cable 321 is then anchored to plate 327 which is secured to the respective stud which is again shown generally at 311 but in this case specific stud is shown at 328.

By reason of the location especially of pulley 326 and the elevated position of the anchor point 329, tension on the cable will have the effect of causing the stud 328 and therefore generally the studs which are linked by the upper rail 302 to be caused to raise.

The further cable 322 is directed by pulley 330 across to pulley 331 and then along to pulley 332 to then end again in coupling to a plate at 333 fixed to the stud generally at 311 but in this case 334.

It will now be seen that by reason of the position of the cradle which acts as a control arm namely 315, the tension and therefore the relative position of the cables and therefore the guard railing as a whole can be controlled at least in terms of it being raised or lowered.

There are several working features in the arrangement shown which can be of relevance.

The first of these is that because the cable is of itself a tension member and not a compression member, when the barrier itself is in a fully erected position, there would be no tendency for it to start to lower unless there were separate means to provide a bias against its erected position.

This then is achieved by spring 335 which is simply a compression spring such that when the stud is in a fully erect position, there is a residual pressure extending the rod 336 with respect to the base 337 which at least starts the retracting position.

When the cradle is in the lowered position, there is an interlock latch at 340 and 341 which includes a spring loaded striker controlled by control bar 342 which however positively locks or allows to be released the control arm 315.

An additional safety factor is that the angular relationship of the cable both in the case of 322 and 321 in connection with the anchor point 323 and 324 is on the further side of the axle 343 about which the control cradle 315 pivots.

This then provides in effect an over centre locking which provides additional safety as far as maintaining the erected position of the barrier 301.

1. A guard railing arrangement on a tanker which extends, when in an erect position, along both sides of a walkway extending along a top of the tank of the tanker.

2. A guard railing arrangement on a tanker as in claim 1 further characterised in that the guard railing is adapted to assume two positions one of which is an erect position providing barrier protection on both sides of the walkway and a second position which is a folded position whereby to be lower than when in the erect position.

3. A guard railing arrangement on a tanker characterised in that the railing is positioned and of a shape to provide a guard barrier along each side of an uppermost walkway of the tank of the tanker which railing extends in a forward to rearward direction along the tank, and where the railing can be held in at least two positions one of which is a lowered storage position and the other of which is a raised barrier position, a ladder extending from the side of the tank to an access part of the walkway on the tank, and control means connected to the guard railing so as to enable a change of the position of the railing.

4. A guard railing arrangement on a tanker as in any one of the preceding claims further characterised in that the railing arrangement includes an uppermost rail which substantially continuously extends along a path above a perimeter of the walkway where the perimeter includes a first side of the walkway, at least one end of the walkway and an opposite side to the said first side of the walkway.

5. A guard railing arrangement on a tanker as in any one of the preceding claims further characterised in that the railing includes a plurality of struts an upper end of each of which is pivotally secured to the or an uppermost rail and a lower end of which is secured in a pivotal manner to the tank of the tanker.

6. A guard railing arrangement on a tanker as in preceding claim 5 further characterised in that the struts are in pairs and are formed so as to be each the leg of a U shape member.

7. A guard railing arrangement on a tanker as in any one of the preceding claims further characterised in that there is included a manually operable control means which is positioned in the adjacent vicinity of an access ladder that an operator can use to gain access to the walkway.

8. A guard railing arrangement on a tanker as in preceding claim 7 further characterised in that there is provided a cradle of generally U shape having each end pivotally secured one to each side of the access ladder, an interconnecting rod being secured to each respective leg and extending at its other end to a respective one of the struts, the connections being such as to allow for pivotal relative movement between the connections, and further being such that with the cradle in a first position, this will maintain the guard railing in a folded position, and in a further position of the cradle, the guard railing is positioned in an erect position.

9. A guard railing arrangement on a tanker as in preceding claim 8 further characterised in that each leg of the cradle has a pivot position relative to the tank such that the pivot connection to the connecting rod can be pushed through an over centre position when the guard railing is erect whereby locking this in position.

10. A guard railing arrangement on a tanker as in preceding claim 8 or 9 further characterised in that there are means to interlock with the cradle when this is in the position with the guard railing in a folded position.

11. A guard railing arrangement on a tanker including a retractable rail extending along the top of the tanker, and an access ladder positioned along the end of the tank to provide access to a passageway above a walkway and defined by the rail, means to effect a change from a retracted to an erect position of the safety rail, the arrangement being characterised in that the rail is comprised of a rail arrangement with a rail positioned on each side of the walkway extending along the top of the tanker, the rail arrangement having a plurality of studs, each stud having a lower end pivotably supported with respect to the tank whereby to be rotatable about an axis aligned to extend transversely to a forward to rearward direction of the tanker, and a support abutment positioned to be adjoining the stud when erect and above the pivot axis.

12. A guard railing arrangement on a tanker as in preceding claim 11 further characterised in that the support abutment comprises an abutment that is positioned on an outer side of the rail when in an erect position.

13. A guard railing arrangement on a tanker as in preceding claim 12 further characterised in that the support abutment is positioned above any pivot connections so that when erect, the stud is further supported by such an abutment against pressure to twist the stud outwardly.

14. A guard railing arrangement on a tanker as in any one of preceding claims 11, 12 or 13 further characterised in that the abutment includes an abutting support on both an outer side, and an inner side of the stud, in both cases, substantially above the pivot connection of the respective stud.

15. A guard railing arrangement on a tanker as in any one of preceding claims 11, 12, 13 or 14, further characterised in that the abutment also includes a rest for an adjacent stud when in a lowered position.

16. A guard railing arrangement on a tanker as in any one of preceding claims 11, 12, 13, 14, or 15 further characterised in that the abutment is a U-shape in cross section and is such that the stud will when in an erect position nest within the U shape which thereby provides support in directions other than in the lowering direction of the stud.

17. A guard railing arrangement on a tanker as in any one of preceding claims further characterised in that a rail arrangement with a rail positioned on each side of the walkway extends along the top of a tanker, the rail arrangement extending from an entry location on one side of the tanker, toward a first end of the tanker, across from one side of the walkway to the other, extending from a first end of the tanker to the other end of the tanker, extending back across the walkway and then returning to the other side of the access location.

18. A guard railing arrangement on a tanker as in any preceding claim 17 further characterised in that there are a plurality of studs pivotally secured at a lower end to a portion of the top of the tanker and having their upper end pivotally secured to the rail and a plurality of studs located at spaced apart intervals to provide for support when the guard railing system is in an erected position.

19. A guard railing arrangement on a tanker as in preceding claim 18 further characterised in that there is provided a control arm located adjacent a ladder secured to a side of the tanker and such that in one position, there are means coupling the lever arm to the guard railing such that it will be held in a raised position, and in a further position of the lever arm, the guard railing is in a lowered position.

20. A guard railing arrangement on a tanker as in preceding claim 19 further characterised in that the means coupling the lever arm to the guard railing include a cable extending from the lever arm around a guide or guides to be secured to at least one of the studs.

21. A guard railing arrangement on a tanker as in any one of preceding claims 19 and 20 further characterised in that the lever arm is comprised of a cradle so that there are two arms each having at an inner end a pivot support relatively fixed to the ladder.

22. A guard railing arrangement on a tanker as in any one of preceding claims 19, 20 and 21 further characterised in that there are two cables one with respect to each of the arms of the U shaped cradle and each extending respectively around a guide member at the top of the tank being secured each to a respective side of the walkway to a respective stud in that location.

23. A guard railing arrangement on a tanker as in preceding claim 21 further characterised in that the arrangement is such that when the cradle is pulled down so as to rotate about its supporting pivot, this in turn will cause the respective cables to be tightened and force the stud to which the respective cables are attached to start to lift and in turn both because there is an upper most safety rail and a mid position cable, this lifting effect on one stud will cause the remainder of the studs to lift as well.

24. A guard railing arrangement substantially as described with respect to any one of the embodiments in the specification with reference to and as illustrated by the accompanying illustrations with respect to that embodiment.
